(19) United States
(12) Patent Application Publication
(10) Pub. No.: US 2024/0401465 A1
(43) Pub. Date: Dec. 5, 2024

(54) USER INTERFACE FOR PRESENTING MULTI-LEVEL MAP CLUSTERS

(71) Applicant: Schlumberger Technology Corporation, Sugar Land, TX (US)

(72) Inventor: Atul Sureka, Pune (IN)

(21) Appl. No.: 18/687,878

(22) PCT Filed: Sep. 2, 2022
(86) PCT No.: PCT/US2022/075923

§ 371 Date: Feb. 29, 2024

(30) Foreign Application Priority Data
Sep. 3, 2021 (IN) 202121040044

(51) Int. Cl. E21B 47/003; G06F 3/04817; G06Q 30/0201; G06T 11/20; G06T 17/05

(52) U.S. Cl. CPC E21B 47/003; G06F 3/04817; G06Q 30/0206; G06T 11/206; G06T 17/05; E21B 2200/20

(57) ABSTRACT

The one or more embodiments provide for a method. The method includes receiving a command to cluster, on an interactive geographical map displayed in a graphical user interface (GUI), objects, each object having a corresponding geographic location defined on the interactive geographical map and property values of properties. The method also includes generating cluster visualizations. Generating the cluster visualizations includes clustering, at least according to the corresponding geographic location, the objects into clusters. Generating also includes creating a corresponding cluster visualization for each corresponding cluster of the clusters. For at least one cluster visualization, the corresponding cluster visualization is created according to a property value of a property, of the properties, of at least some of the objects in the corresponding cluster. The method also includes displaying the cluster visualizations on the interactive geographical map in the GUI.

### CROSS REFERENCE PARAGRAPH

This application claims the benefit of India Application No. 202121040044, entitled “USER INTERFACE FOR PRESENTING MULTI-LEVEL MAP CLUSTERS,” filed Sep. 3, 2021, the disclosure of which is hereby incorporated herein by reference.

### BACKGROUND

Graphical user interface (GUI) may be used to present information to a user. For example, a GUI may be used to present geographical maps that show geographical locations of objects with respect other objects and geographical features. Occasionally the density of objects prohibits displaying each of the objects individually. In such a scenario, clustering is used whereby objects that are near each other are grouped together into a single point. Each point represents multiple objects that are located within a threshold to each other.

### SUMMARY

The one or more embodiments provide for a method. The method includes receiving a command to cluster, on an interactive geographical map displayed in a graphical user interface (GUI), objects, each object having a corresponding geographic location defined on the interactive geographical map and property values of properties. The method also includes generating cluster visualizations. Generating the cluster visualizations includes clustering, at least according to the corresponding geographic location, the objects into clusters. Generating also includes creating a corresponding cluster visualization for each corresponding cluster of the clusters. For at least one cluster visualization, the corresponding cluster visualization is created according to a property value of a property, of the properties, of at least some of the objects in the corresponding cluster. The method also includes displaying the cluster visualizations on the interactive geographical map in the GUI.

The one or more embodiments also provide for a system. The system includes a processor and a data repository in communication with the processor and storing objects having a corresponding geographic location and property values of properties. The system also includes a clustering process executable by the processor to cluster, at least according to the corresponding geographic location, the objects into clusters. The clustering process is also executable to create cluster visualizations for the clusters. At least one cluster visualization in the cluster visualizations is created according to a property value of a property, of the properties, of at least some of the objects in a corresponding cluster of the clusters. The system also includes a map application executable by the processor and including a graphical user interface (GUI) including an interactive geographical map displaying the cluster visualizations. The corresponding geographic location is defined on the interactive geographical map.

The one or more embodiments also provide for a graphical user interface (GUI) of a computing system. The graphical user interface includes a display of cluster visualizations on an interactive geographical map displayed on the GUI. The cluster visualizations is formed by a processor executing a computer-implemented method. The computer-implemented method includes receiving a command to cluster, on the interactive geographical map displayed in the GUI, objects, each object having a corresponding geographic location defined on the interactive geographical map and property values of properties. The computer-implemented method also includes generating cluster visualizations. Generating the cluster visualizations includes clustering, at least according to the corresponding geographic location, the objects into clusters. Generating also includes creating a corresponding cluster visualization for each corresponding cluster of the clusters. For at least one cluster visualization, the corresponding cluster visualization is created according to a property value of a property, of the properties, of at least some of the objects in the corresponding cluster. The GUI also includes a widget displayed in association with at least one of the cluster visualizations. The widget is operable by a user to alter, on the GUI, the at least one of the cluster visualizations.

Other aspects of the one or more embodiments will be apparent from the following description and the appended claims.

### BRIEF DESCRIPTION OF DRAWINGS

FIG. 1.1 and FIG. 1.2 together show a computing system, in accordance with one or more embodiments.

FIG. 2.1 and FIG. 2.2 are computer algorithms, in accordance with one or more embodiments.

FIG. 3.1 is an example exploration and production system in which the cluster visualization techniques of FIG. 1.1 through FIG. 2.2 may be implemented, in accordance with one or more embodiments;

FIG. 3.2, FIG. 3.3, FIG. 3.4, FIG. 3.5, FIG. 3.6, FIG. 3.7, and FIG. 3.8, are example GUIs, in accordance with one or more embodiments.

FIG. 4.1 and FIG. 4.2 represent a computer system and a network environment, in accordance with one or more embodiments.

### DETAILED DESCRIPTION

Specific embodiments will now be described in detail with reference to the accompanying figures. Like elements in the various figures are denoted by like reference numerals for consistency.

The figures show diagrams of embodiments that are in accordance with the disclosure. The embodiments of the figures may be combined and may include or be included within the features and embodiments described in the other figures of the application. The various elements, systems, components, and blocks shown in the figures may be omitted, repeated, combined, and/or altered as shown from the figures. Accordingly, the scope of the present disclosure should not be considered limited to the specific arrangements shown in the figures.

In the following detailed description of embodiments, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the term “connected to” contemplates multiple meanings. A connection may be direct or indirect. For example, computing system A may be directly connected to computing system B by means of a direct communication link, a common network environment to which both computing systems are wired or wirelessly connected. A connection may be temporary, permanent, or semi-permanent communication channel between two computing systems.

In general, the one or more embodiments relate to graphical representation of complex information on a graphical user interface (GUI) generated by a computing system. In particular, the one or more embodiments are directed to displaying additional non-location-based information when rendering a visualization of one or more clusters on the GUI. The visualizations may be represented as different shapes, colors, graphs, etc. in order to increase the amount of information displayed on the GUI while minimizing clutter on the GUI.

Thus, the one or more embodiments address the significant technical challenge of displaying an overwhelming amount of information on a GUI in a manner useful to a human user. The term “overwhelming,” as used herein, refers to an amount of information that, if directly rendered on the GUI, would be deemed by a computer scientist to be practically unusable or unintelligible to a human user, or which would be more understandable to a human user if presented in a different visual format. For example, a technical challenge exists when a single GUI on an interactive map has to display thousands of objects as well as the properties of the objects. The density of information is likely to render the resulting GUI unintelligible and unhelpful.

The one or more embodiments address the above-identified technical challenge by clustering the information into cluster visualizations and displaying the cluster visualizations on the GUI. The one or more embodiments also increase the amount of information that is displayed in the cluster visualizations by changing the shape, size, color, and/or type of the cluster visualizations, and/or by displaying text in the cluster visualizations. In this manner, the GUI representation of the underlying data is made more useful to the human user. Continuing the above example, the one or more embodiments may present the million data points as a set of twenty cluster visualizations, in which the size, shape, color, type, and embedded text of the twenty cluster visualizations are varied in order to convey meaningful information graphically to a human user.

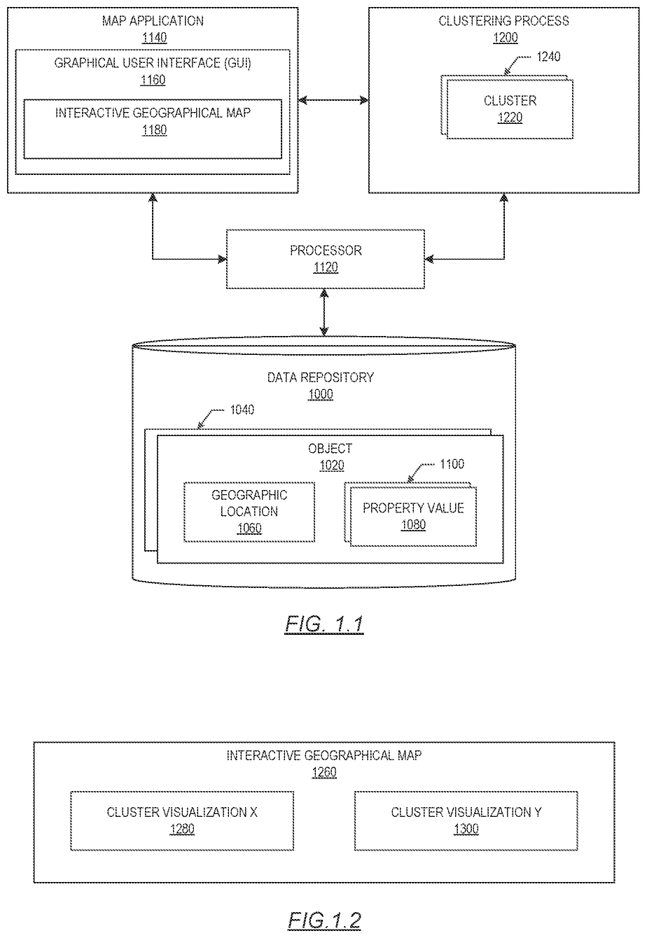

Attention is now turned to the figures. FIG. 1.1 and FIG. 1.2 together show a computing system, in accordance with one or more embodiments. The computing system shown in FIG. 1.1 includes a data repository (1000). In one or more embodiments, the data repository (1000) is a storage unit and/or device (e.g., a file system, database, collection of tables, or any other storage mechanism) for storing data. Further, the data repository (1000) may include multiple different storage units and/or devices. The multiple different storage units and/or devices may or may not be of the same type and may or may not be located at the same physical site.

The data repository (1000) stores an object (1020) among possibly multiple objects (1040). The object (1020) is a computer-readable data structure that stores information about an entity. The entity may be a real object, a planned object, a social construct (e.g., a well head, a person, a voting location, an automobile, city, etc.), or a virtual object (e.g., an avatar, virtual building, etc.).

In an example, the object (1020) and the multiple objects (1040) are associated with at least two different forms of information, a geographic location (1060) on a real map or a virtual map, and a property value (1080) among possibly multiple property values (1100). The geographic location (1060) is a real location of a real object on a map, or a virtual location of a virtual object on a virtual map. Specifically, the geographic location (1060) identifies the position of the object within the map. The coordinates used to express the geographic location (1060) may vary, but may be, for example, X-Y coordinates, spherical coordinates, latitudinal and longitudinal coordinates, etc.

The property value (1080) describes a property of the object (1020). The property is an attribute of the object (1020) that does not specify the position of the object within the map. Thus, whereas the geographic location defines position, the attribute does not identify position. For example, the property may be the amount of production from a well head, a status of a well head, a make or model of an automobile, a job title of a person, a number of machines at a location, etc. A same object (1020) may have multiple property values (1100); for example, a well head may have multiple property values (1100) that reflect a well head type, a status of the well head, the amount of production from a well head, etc. Thus, there may be multiple objects (1040), each with multiple property values (1100). However, each object (1020) is associated with only one geographic location (1060).

The system shown in FIG. 1.1 also includes a processor (1120) in communication with the data repository (1000). The processor (1120) is one or more hardware and/or virtual processors, possibly in a distributed computing environment. The processor (1120) executes software applications, such as the map application (1140) and the clustering process (1200) described below.

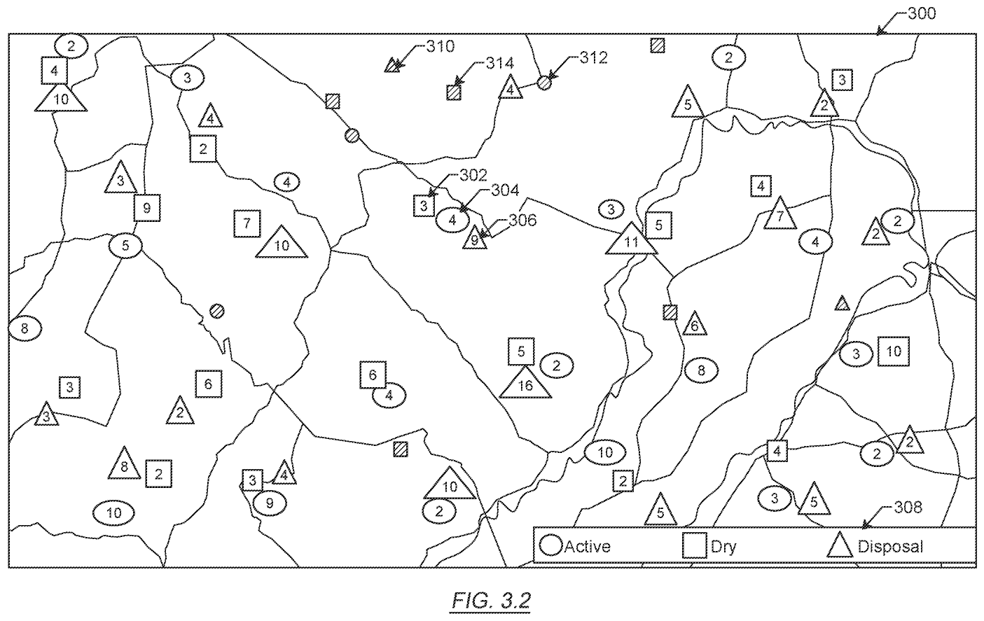

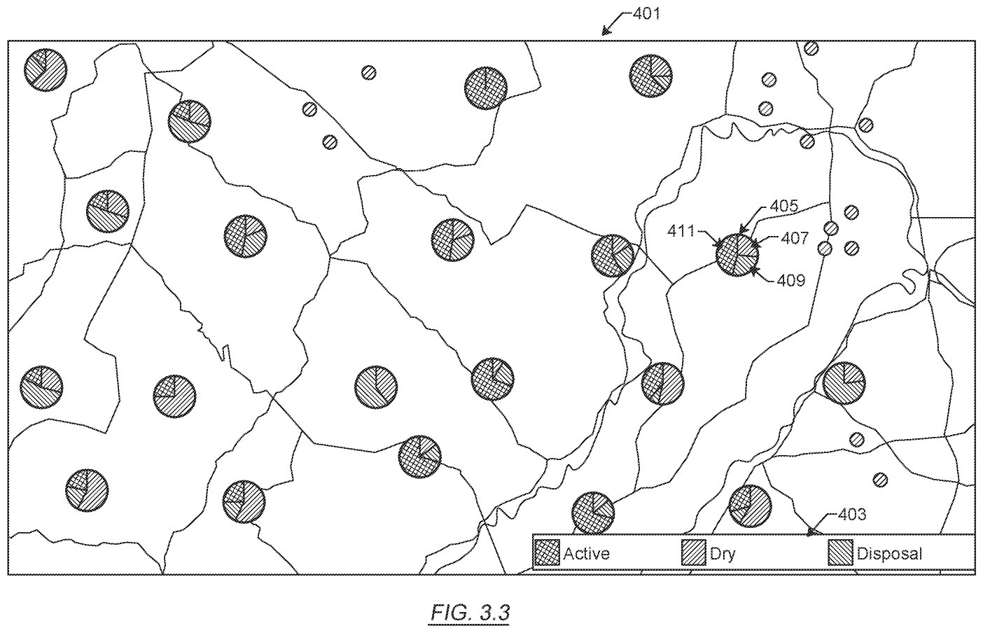

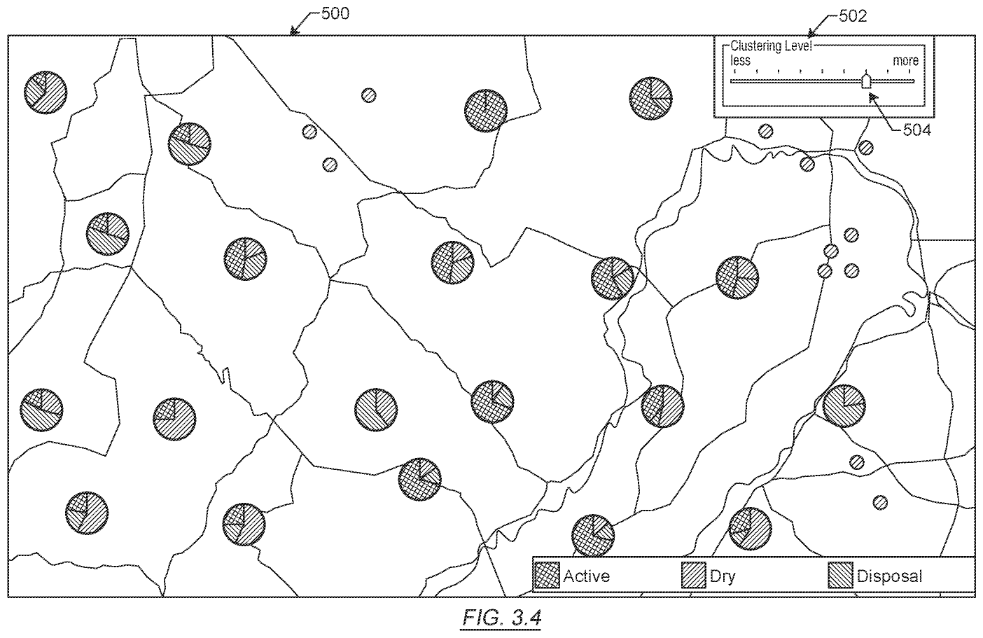

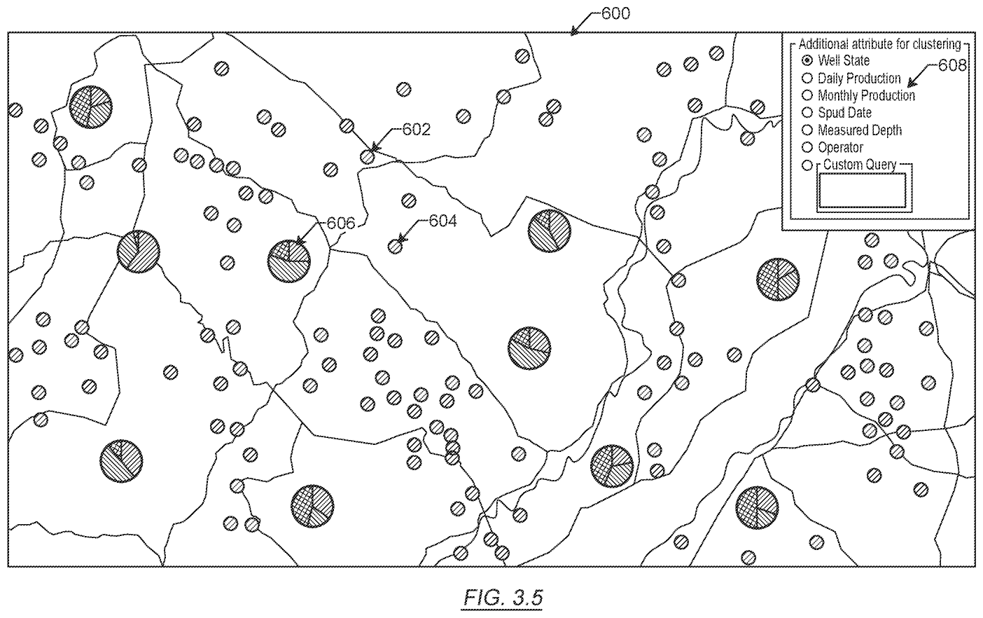

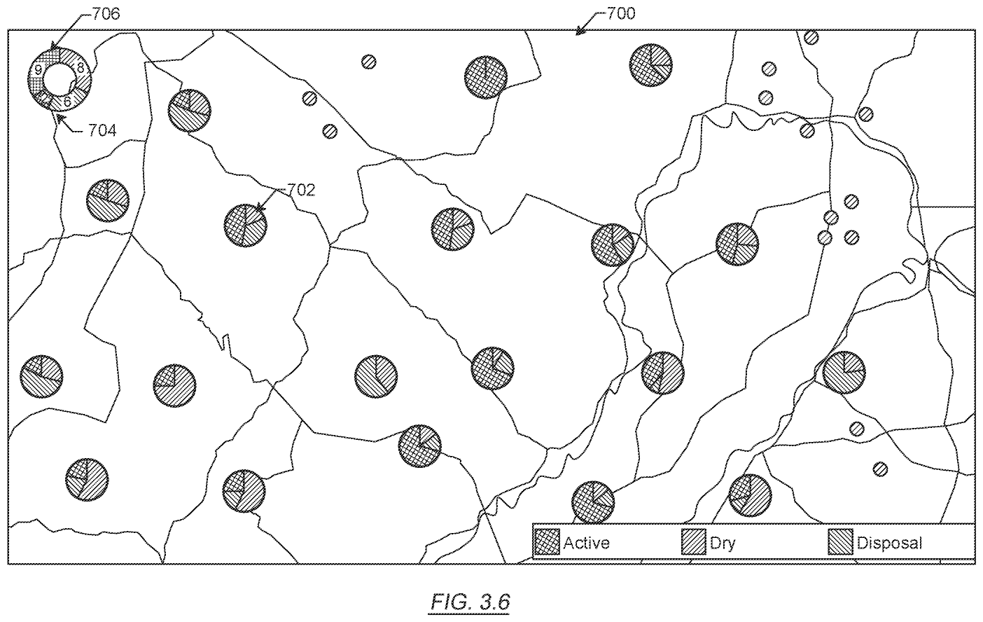

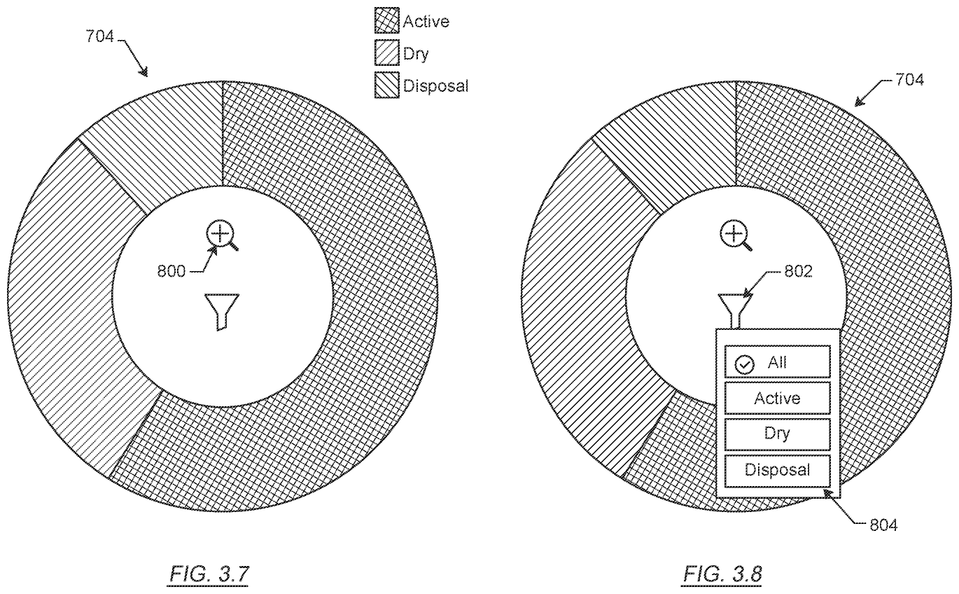

The system shown in FIG. 1.1 also includes a map application (1140). The map application (1140) is a software application that is executable by the processor (1120) to generate or modify a graphical user interface; i.e., GUI (1160). The GUI (1160) is displayed on a display device also in communication with the processor (1120). Examples of the GUI (1160) are shown in FIG. 3.2 through FIG. 3.8.

The system shown in FIG. 1.1 also includes an interactive geographical map (1180). The interactive geographical map (1180) is displayed on the GUI (1160). The interactive geographical map (1180) is a map of a geographical place, either real or virtual. The interactive geographical map (1180) is “interactive” because a user may interact with graphical objects and/or GUI widgets displayed on or near the interactive geographical map (1180) on the display device which shows the GUI (1160). A GUI widget is software graphical element displayed on a GUI that is configured to receive user input and/or display output in order to manipulate the software. Examples of widgets include, but are not limited to, a drop-down menu, a scrollbar, a pop-up window, a button, a wheel, etc.

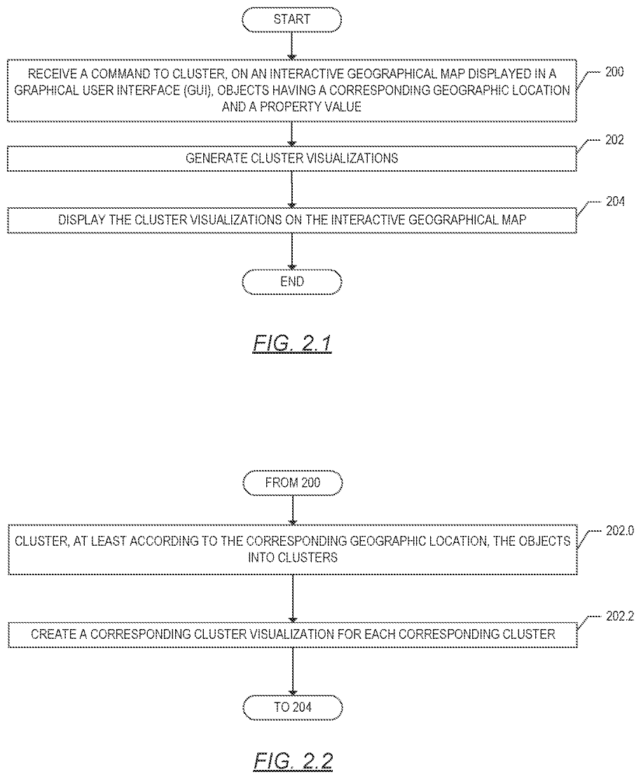

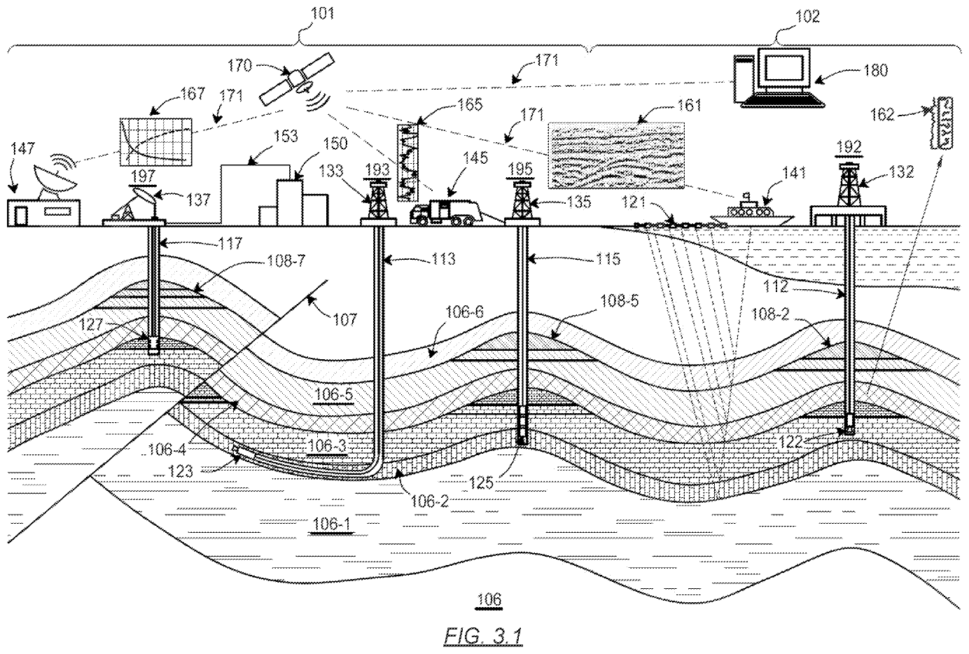

The system shown in FIG. 1 also includes a clustering process (1200). The clustering process (1200) is a software application that is executable by the processor (1120) to cluster the multiple objects (1040) into a cluster (1220) or possibly into multiple clusters (1240). The algorithm for the clustering process (1200) is described with respect to FIG. 2.1 and FIG. 2.2.

The cluster (1220) is a grouping of at least two of the multiple objects (1040). The cluster (1220) is generated using the clustering process (1200), as described with respect to FIG. 2.1 and FIG. 2.2. The cluster (1220) is represented on the interactive geographical map (1180) as a visualization, as described with respect to FIG. 1.2. The cluster (1220) may be one of multiple clusters (1240) determined by the clustering process (1200) for representation as visualizations on the interactive geographical map (1180).

Attention is now turned to FIG. 1.2. FIG. 1.2 shows an interactive geographical map (1260). The interactive geographical map (1260) may be the interactive geographical map (1180) described with respect to FIG. 1.1. The interactive geographical map (1260) may show geographical terrain and/or locations of places, objects, or people.

The interactive geographical map (1260) also displays one or more cluster visualizations, such as cluster visualization X (1280) and cluster visualization Y (1300). A cluster visualization is a graphical object displayed on the interactive geographical map (1260), such as but not limited to a marker, a polygon, a flag, a circle, a toroid, a donut, a graph, a chart, etc.

While FIG. 1.1 and FIG. 1.2 show a configuration of components, other configurations may be used without departing from the scope of the one or more embodiments. For example, various components may be combined to create a single component. As another example, the functionality performed by a single component may be performed by two or more components.

FIG. 2.1 and FIG. 2.2 are computer algorithms, in accordance with one or more embodiments. Thus, the flowcharts shown in FIG. 2.1 and FIG. 2.2 may be implemented as computer readable program code to generate the cluster (1220), the interactive geographical map (1180), the interactive geographical map (1260), the cluster visualization X (1280), and the cluster visualization Y (1300) of FIG. 1, for example.

Step 200 includes receiving a command to cluster, on an interactive geographical map displayed in a graphical user interface (GUI), objects having a corresponding geographic location and a property value. As described with respect to FIG. 1.1, the geographic location is defined on the interactive geographical map. Also as described with respect to FIG. 1.1, the property value relates to the objects displayed on the interactive geographical map.

The command to cluster may be received from a human user, such as by interacting with the interactive geographical map or by issuing some other command to the computing system executing the clustering process that executes the command to cluster. The command to cluster may also be received from another process executed by the processor. For example, another process may be used to determine the number of well heads to display on the interactive geographical map, and the output of that process be fed to a clustering process that treats the output as the command to cluster.

The command to cluster may, or may not, be dependent on the display of the interactive geographical map. Thus, the interactive geographical map may be displayed prior to receiving the command, or after receiving the command. The interactive geographical map could also be displayed in response to receiving the command.

Step 202 includes generating cluster visualizations. Generating the cluster visualizations may be part of generating the clusters, as in step 202.0 below in FIG. 2.2, or may be performed after clusters have been generated. The cluster visualizations may be generated using the method of FIG. 2.2.

Step 204 includes displaying the cluster visualizations on the interactive geographical map in the GUI. Displaying may be performed by the processor issuing a command to render the cluster visualizations on the GUI. The display may be indirect. For example, the display may be performed by transmitting the generated cluster visualizations to a remote computing system, and the remote computing system displaying the cluster visualizations. Thus, for example, receiving the command at step 200, generating at step 202, and displaying at step 204 may be performed all on the same computing system, or on one or more different computing systems.

Attention is now turned to FIG. 2.2. FIG. 2.2 shows steps for implementing step 202 in FIG. 2.1.

Step 202.0 includes clustering, at least according to the corresponding geographic location, the objects into clusters. Clustering may be performed by executing a clustering process on objects defined with respect to the interactive geographical map, or by obtaining previously generated clusters of objects.

The clustering process may use one or more clustering algorithms. Examples of clustering algorithms include hierarchical greedy clustering, point clustering, heat map clustering, clustering by object geographic location, clustering by object property value(s), clustering by a combination of object geographic location and object property value(s), layered clustering, etc. The selected clustering algorithm clusters together objects into a set of visualizations, as described below in step 202.2. Each visualization in the set represents a grouping of multiple objects on the interactive geographical map.

An example clustering algorithm may proceed as follows. A group of objects having a threshold number of objects and that are geographically within a diameter of each other are identified. The diameter and the threshold number may be configurable. For example, the threshold number may be two or any number greater than two. The group is selected as a cluster. The centroid of the cluster may be selected as the location of a visualization representing the cluster.

The clustering process may cluster the objects according to one or more parameters. For example, the clustering process may cluster objects by geographic location. The clustering process may cluster objects by object property or properties. The clustering process may cluster objects by a combination of geographic location and object property or properties. The clustering process may cluster objects according to one or more rules in conjunction with one or more of object location and property or properties.

Step 202.2 includes creating a corresponding cluster visualization for each corresponding cluster. The cluster visualization, like the clustering process, may be dependent upon object location, object property or properties, or a combination thereof. Thus, for at least one cluster visualization, the corresponding cluster visualization may be created according to a property value of a property of at least some of the objects in the corresponding cluster. However, the cluster visualization generation is different than the clustering process, and thus the two steps need not follow the same rules or be based on the same geographic locations and/or properties.

Two techniques may be used for the operations of FIG. 2.2 in order to generate a visualization for a cluster that is based on the property value. In the first technique, the property is used in Block 202.0 when creating the clusters. For example, the objects may be grouped into subsets based on having a same property value or a property value in a defined range of property values for the subsets. Then, the clustering process, described above, may be individually performed for each subset to cluster based on geographic location. Thus, each cluster represents a corresponding particular property value or range of property values. The visualization may be in a shape representing the property value or range of property values assigned to the cluster.

In a second technique, the clustering process may generate the clusters by clustering the objects according to only the geographical locations of the objects. Then, the cluster visualizations for the clusters are generated by representing the clusters according to the non-geographic location properties of the objects. For example, if the objects are well heads, then each cluster visualization may be generated based on the production data for the well heads. Thus, for example, the different within the cluster visualizations represent different production levels for the well heads. By way of an example, the visualization may be graphs of the property values for objects in the cluster. Rather than having a user select a dot or other shape for the cluster and then displaying the graph, the graph is directly displayed on the interactive geographical map as the representation for the cluster.

The two techniques described above may be combined, for example, as follows for different property values. For example, the first technique may be used to cluster objects based on object type (e.g., as represented by a property value) as well as geographic location. Then, a visualization may be added according to the second technique that shows another property for the cluster. For example, if the objects are wells. The first technique may be performed to cluster objects based on geographic location of the wells and whether the wells are active or inactive. The second technique may be used to add a graph showing the percentage of the active wells in the cluster producing within each predefined range as defined by a second property.

Examples of different clustering visualizations are shown in FIG. 3.2 through FIG. 3.8.

The methods of FIG. 2.1 and FIG. 2.2 may be varied. For example, the objects may be grouped into different clusters based on both the corresponding geographic location and the property values. Alternatively, the objects may be grouped into different clusters based on only the property values. The objects may be grouped into different clusters based on a weighting assigned to at least one of the corresponding geographic location and the property values. For example, when generating the clusters according to both geographic location and property values, the clusters may be generated by giving certain geographic locations a greater weight than the property values or other geographic locations.

The method of FIG. 2.1 may be extended. For example, the method may also include altering, based on the property values, a shape of at least some of the cluster visualizations. An example of changing shapes of the cluster visualizations is shown in FIG. 3.2.

In another example, the method may include displaying the cluster visualizations as pie charts, the pie charts modified using the property values. An example of using pie charts for the cluster visualizations is shown in FIG. 3.3 through FIG. 3.5.

In another example, the method may include displaying the cluster visualizations as donut charts, the donut charts modified using the property values. An example of using donut charts for the cluster visualizations is shown in FIG. 3.6 through FIG. 3.8.

The donuts charts may be further modified. For example, the method may also include displaying a corresponding widget within inner circles of the donut charts. The corresponding widget is configured to further alter display of one or more of the donuts charts based on the property values. For example, as shown in FIG. 3.7 and FIG. 3.8, a zoom widget or a property widget may be generated within the inner circle of a donut chart of a cluster visualization.

Still other variations are possible. For example, the method may also include displaying the cluster visualizations as graphs, the graphs modified using the property values. Thus, for example, a cluster visualization could be a bar graph, a line graph, or some other graph showing properties of objects that are contained within the cluster visualization.

In still another variation, a GUI may show clusters having a variety of different cluster visualizations. Thus, for example, an interactive geographical map may include cluster visualizations represented as a combination of different shapes, pie charts, donut charts, graphs, or other types of cluster visualizations.

While the various steps in the flowcharts of FIG. 2.1 and FIG. 2.2 are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments. By way of an example, determination steps may not require a processor to process an instruction unless an interrupt is received to signify that condition exists in accordance with one or more embodiments. As another example, determination steps may be performed by performing a test, such as checking a data value to test whether the value is consistent with the tested condition in accordance with one or more embodiments. Thus, the one or more embodiments are not necessarily limited by the examples provided herein.

FIG. 3.1 through FIG. 3.8 present a specific example of the techniques described above with respect to FIG. 1.1 through FIG. 2.2. The following example is for explanatory purposes only and not intended to limit the scope of the one or more embodiments.

FIG. 3.1 is an example exploration and production system in which the cluster visualization techniques of FIG. 1.1 through FIG. 2.2 may be implemented, in accordance with one or more embodiments. As shown in FIG. 3.1, the fields (101), (102) include a geologic sedimentary basin (106), wellsite systems (192), (193), (195), (197), wellbores (112), (113), (115), (117), data acquisition tools (121), (123), (125), (127), surface units (141), (145), (147), well rigs (132), (133), (135), production equipment (137), surface storage tanks (150), production pipelines (153), and an E&P computing system (180) connected to the data acquisition tools (121), (123), (125), (127), through communication links (171) managed by a communication relay (170).

The cluster visualization techniques described with respect to FIG. 1.1 through FIG. 2.2 may be useful when displaying an interactive geographical map showing many of the objects described above with respect to FIG. 3.1. For example, the wellbores (112), (113), (115), and (117) may be displayed on the interactive geographic map as a single cluster among multiple clusters of other wellbores in different sites in a broader geographical region In another example, the wellsite systems (192) and (193) may be in one cluster visualization and the wellsite systems (195) and (197) may be shown in another cluster visualization.

The cluster visualizations are then adjusted in size, shape, or image type (e.g., pie chart, donut chart, graph, table, etc.) based on the properties of the objects in the cluster. For example, a pie chart may show production values of different substances produced by well sites represented by a cluster visualization. In another example, a donut chart can show the relative maintenance status of wellsite systems represented by a cluster visualization. Many other examples of clustering the various objects described with respect to FIG. 3.1 and then changing the cluster visualizations for the clusters based on the properties of the objects represented by the clusters.

Furthermore, different types of items may appear on an interactive geographical map. For example, multiple cluster visualization types may appear for different objects, such as but not limited to clusters of (141), (145), (147), well rigs (132), (133), (135), clusters of production equipment (137), clusters of surface storage tanks (150), clusters of production pipelines (153), etc. In each case, a different cluster visualization may be presented so that, when the interactive geographical map is viewed as a whole, a vast amount of information may be presented visually in a manner that is useful to a human user. When desired, the human user can use widgets and/or other commands for the interactive geographical map to obtain more information on a particular cluster visualization, to increase or decrease the degree or granularity of clustering, change the properties that are represented in the cluster visualizations, etc.

Attention is returned to FIG. 3.1. The geologic sedimentary basin (106) contains subterranean formations. As shown in FIG. 3.1, the subterranean formations may include several geological layers (106-1 through 106-6). As shown, the formation may include a basement layer (106-1), one or more shale layers (106-2, 106-4, 106-6), a limestone layer (106-3), a sandstone layer (106-5), and any other geological layer. A fault plane (107) may extend through the formations. In particular, the geologic sedimentary basin includes rock formations and may include at least one reservoir including fluids, for example, the sandstone layer (106-5). The rock formations may include at least one seal rock, for example, the shale layer (106-6), which may act as a top seal. The rock formations may include at least one source rock, for example, the shale layer (106-4), which may act as a hydrocarbon generation source. The geologic sedimentary basin (106) may further contain hydrocarbon or other fluids accumulations associated with certain features of the subsurface formations. For example, accumulations (108-2), (108-5), and (108-7) associated with structural high areas of the reservoir layer (106-5) and containing gas, oil, water or any combination of these fluids.

Data acquisition tools (121), (123), (125), and (127), may be positioned at various locations along the field (101) or field (102) for collecting data from the subterranean formations of the geologic sedimentary basin (106), referred to as survey or logging operations. In particular, various data acquisition tools are adapted to measure the formation and detect the physical properties of the rocks, subsurface formations, fluids contained within the rock matrix and the geological structures of the formation. For example, data plots (161), (162), (165), and (167) are depicted along the fields (101) and (102) to demonstrate the data generated by the data acquisition tools. Specifically, the static data plot (161) is a seismic two-way response time. Static data plot (162) is core sample data measured from a core sample of any of subterranean formations (106-1 to 106-6). Static data plot (165) is a logging trace, referred to as a well log. Production decline curve or graph (167) is a dynamic data plot of the fluid flow rate over time. Other data may also be collected, such as historical data, analyst user inputs, economic information, and/or other measurement data and other parameters of interest.

The acquisition of data shown in FIG. 3.1 may be performed at various stages of planning a well. For example, during early exploration stages, seismic data may be gathered from the surface to identify possible locations of hydrocarbons. The seismic data may be gathered using a seismic source that generates a controlled amount of seismic energy. In other words, the seismic source and corresponding sensors (121) are an example of a data acquisition tool. An example of seismic data acquisition tool is a seismic acquisition vessel (141) that generates and sends seismic waves below the surface of the earth. Sensors (121) and other equipment located at the field may include functionality to detect the resulting raw seismic signal and transmit raw seismic data to a surface unit, e.g., the seismic acquisition vessel (141). The resulting raw seismic data may include effects of seismic wave reflecting from the subterranean formations (106-1 to 106-6).

After gathering the seismic data and analyzing the seismic data, additional data acquisition tools may be employed to gather additional data. Data acquisition may be performed at various stages in the process. The data acquisition and corresponding analysis may be used to determine where and how to perform drilling, production, and completion operations to gather downhole hydrocarbons from the field. Generally, survey operations, wellbore operations and production operations are referred to as field operations of the field (101) or (102). These field operations may be performed as directed by the surface units (141), (145), (147). For example, the field operation equipment may be controlled by a field operation control signal that is sent from the surface unit.

Further as shown in FIG. 3.1, the fields (101) and (102) include one or more wellsite systems (192), (193), (195), and (197). A wellsite system is associated with a rig or a production equipment, a wellbore, and other wellsite equipment configured to perform wellbore operations, such as logging, drilling, fracturing, production, or other applicable operations. For example, the wellsite system (192) is associated with a rig (132), a wellbore (112), and drilling equipment to perform drilling operation (122). A wellsite system may be connected to a production equipment. For example, the well system (197) is connected to the surface storage tank (150) through the fluids transport pipeline (153).

The surface units (141), (145), and (147), may be operatively coupled to the data acquisition tools (121), (123), (125), (127), and/or the wellsite systems (192), (193), (195), and (197). In particular, the surface unit is configured to send commands to the data acquisition tools and/or the wellsite systems and to receive data therefrom. The surface units may be located at the wellsite system and/or remote locations. The surface units may be provided with computing system facilities (e.g., an E&P computing system) for receiving, storing, processing, and/or analyzing data from the data acquisition tools, the wellsite systems, and/or other parts of the field (101) or (102). The surface unit may also be provided with, or have functionality for actuating, mechanisms of the wellsite system components. The surface unit may then send command signals to the wellsite system components in response to data received, stored, processed, and/or analyzed, for example, to control and/or optimize various field operations described above.

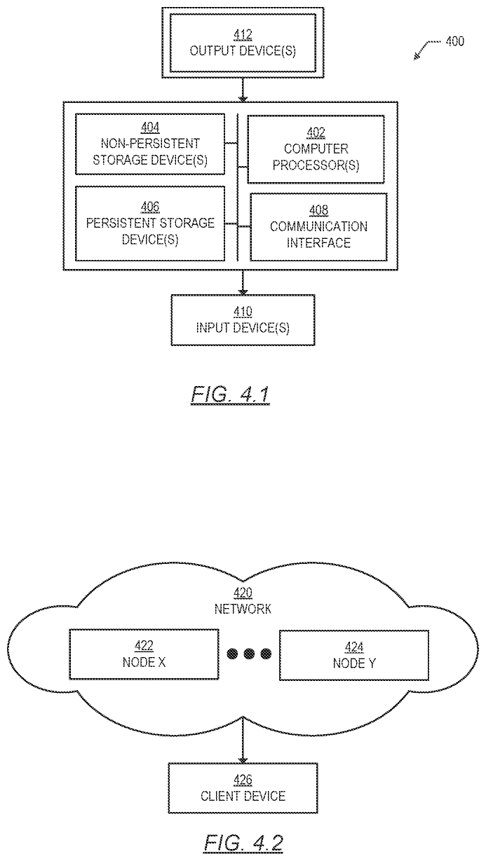

The surface units (141), (145), and (147) may be communicatively coupled to the E&P computing system (180) via the communication links (171). The communication between the surface units and the E&P computing system (180) may be managed through a communication relay (170). For example, a satellite, tower antenna or any other type of communication relay may be used to gather data from multiple surface units and transfer the data to a remote E&P computing system (180) for further analysis. Generally, the E&P computing system (180) is configured to analyze, model, control, optimize, or perform management tasks of the aforementioned field operations based on the data provided from the surface unit. The E&P computing system (180) may be provided with functionality for manipulating and analyzing the data, such as analyzing seismic data to determine locations of hydrocarbons in the geologic sedimentary basin (106) or performing simulation, planning, and optimization of E&P operations of the wellsite system. The results generated by the E&P computing system (180) may be displayed for a user to view the results in a two-dimensional (2D) display, three-dimensional (3D) display, or other suitable displays. Although the surface units are shown as separate from the E&P computing system (180) in FIG. 3.1, in other examples, the surface unit and the E&P computing system (180) may also be combined. The E&P computing system (180) and/or surface unit may correspond to a computing system, such as the computing system shown in FIG. 4.1 and FIG. 4.2 and described below.

Any of the objects described with respect to FIG. 3.1 could be clustered and then represented by cluster visualizations that have been generated, adapted, or changed based on the properties of the objects. Thus, for example, the underground formations could be represented as clusters and the properties of the underground structures (density, rock type, etc.) be represented as charts or graphs that are shown as being the cluster visualizations. Thus, as described above, the one or more embodiments contemplate many different applications for cluster visualizations of E&P objects on an interactive geographical map.

Attention is now turned to FIG. 3.2. An interactive geographical map (300) shows different cluster visualizations, such as cluster visualization (302), cluster visualization (304), and cluster visualization (306). The interactive geographical map (300) is a map of a portion of the Earth, and the cluster visualizations relate to E&P objects, such as those described with respect to FIG. 3.1. For reference, individual E&P objects are shown, such as E&P object (310), E&P object (312), and E&P object (314).

In the example of FIG. 3.2, the clusters visualizations represent clusters of wellheads. A property of any given wellhead may be status, such as active, dry, or in a disposal process (“disposal”). The wellheads in the interactive geographical map (300) of FIG. 3.2 are clustered according to a combination of geographical location and property. Thus, for example, 16 wellheads in the region of the cluster visualization (302), cluster visualization (304), and cluster visualization (306) are clustered into to three clusters. The cluster visualization (302) represents wellheads that are dry; the cluster visualization (304) represents wellheads that are active; and the cluster visualization (306) represents wellheads that are in disposal. The shape of the cluster visualizations allows a human user to see, at a glance, which clusters pertain to a given wellhead type, as shown by legend (308).

A number is displayed within each cluster visualization to show the number of wellheads in a particular cluster. Thus, for example, for cluster visualization (304) the number “4” represents four wellheads in the cluster. The number may also represent groups of wellheads. Thus, for example, the number “4” could represent 40 wellheads or 4000 wellheads.

To complete the information shown in the interactive geographical map (300), individual wellheads may be shown if too few wellheads are present in a region to be clustered. Thus, for example, the E&P object (310) may represent a single disposal wellhead, the E&P object (312) may represent a single active wellhead, and the E&P object (314) may represent a single a single dry wellhead.

The size of the cluster visualizations may show additional information, other than the number of wellheads. For example, the cluster visualization (304) is larger than the cluster visualization (306), even though the cluster visualization (304) has fewer wellheads than the cluster visualization (306). Thus, other information is being conveyed by the size of the cluster visualizations.

The other information may be one or more of a variety of other non-location properties of the wellheads within a cluster. For example, the non-location properties may include well state, spud date, measured depth, field information, operator, logs, field, deviation, drill type, etc. In the example of FIG. 3.2, the non-location property in question is measured depth. In this case, larger cluster visualizations represent deeper wells, on average, relative to smaller clusters. Thus, the average depth of wells in the cluster visualization (304) is deeper than the average depth of wells in the cluster visualization (306). However, many different properties could be used to change the size, color, shading, etc. of the cluster visualizations.

Additionally, a user may change the properties to be represented by the cluster visualizations. Thus, for example, the user could use a widget associated with the interactive geographical map (300) to indicate that the size of the cluster visualizations instead represents spud dates, with older spud dates shown as larger cluster visualizations.

From the above description it can be seen that FIG. 3.2 shows an example of a user interface for presenting multi-level map clusters. The interactive geographical map (300) is a user interface, which is interactive with user input. The map clusters have multiple levels of information based on their size, shape, location, displayed numbers, etc. Each type of information is another level of information. Thus, for example, cluster visualization (302) has at least four levels of information: the location of the cluster visualization (302) indicates a centroid of wells in the cluster, the elliptical shape of the cluster visualization (302) indicates that the wells in the cluster are active, the number displayed inside of the cluster visualization (302) indicates the number of wells in the cluster, and the size of the cluster visualization (302) indicates, in one example, spud dates in a particular age range. Other examples of user interfaces for presenting multi-level map clusters are shown in FIG. 3.3 through FIG. 3.6.

Attention is now turned to FIG. 3.3. In the example of FIG. 3.3, the interactive geographical map (401) includes cluster visualizations shown as pie charts. Shades in the pie charts indicate wellhead properties, as indicated by legend (403). Thus, the shades in the pie charts of the cluster visualizations of FIG. 3.3 represent similar information to the shape of cluster visualizations shown in FIG. 3.2.

For example, consider cluster visualization (405), which is represented as a pie chart. The cluster visualization (405) includes a first section (407), a second section (409), and a third section (411). The degree of shading in the sections indicate the type of well head. Thus, the first section (407) represents dry wellheads, the second section (409) represents disposal wellheads, and the third section (411) represents dry wellheads. The relative area taken up by each section indicates the relative prevalence of the indicated type of wellhead, relative to the other wellheads in the cluster corresponding to the cluster visualization (405).

Attention is turned to FIG. 3.4. FIG. 3.4 shows the same arrangement of cluster visualizations as that shown in FIG. 3.3. Thus, the interactive geographical map (500) is substantially similar to the interactive geographical map (401) shown in FIG. 3.3. However, the user has issued a command to display a widget (502) which the user may manipulate to adjust the degree to which wellheads are clustered. In particular, the user manipulates a slider bar (504) to indicate that the clustering level should be reduced (i.e., that wellheads must be closer together in order to be placed within a cluster).

The result of manipulating the slider bar (504) in FIG. 3.4 is the set of cluster visualizations shown in interactive geographical map (600) shown in FIG. 3.5. As can be seen in FIG. 3.5, more individual wellheads, represented by markers such as marker (602) and marker (604) are shown. Fewer cluster visualizations, such as cluster visualization (606) are shown.

In addition, FIG. 3.5 shows an additional interactive widget (608). The interactive widget (608) is operable by the user to change which non-location data is represented by the cluster visualizations. Currently, well-state (e.g., active, dry, disposal) is shown, but as indicated in the interactive widget (608) other properties such as daily production, monthly production, spud date, measured depth, operator, or a custom property could be used to change how the cluster visualizations are presented on the interactive geographical map (600).

FIG. 3.6 shows another example of an interactive geographical map (700), in which some of the cluster visualizations may be different from each other. Thus, for example, the cluster visualization (702) is a pie chart and the cluster visualization (704) is a donut chart. The determination of how a cluster visualization is shown may be based on the number of objects in a cluster, the type of properties to be presented in a cluster visualization, user instruction, or some other basis.

In the example of FIG. 3.6, the cluster visualization (704) shows a donut chart indicating well state according to the same shading scheme shown in FIG. 3.2 through FIG. 3.5. However, the relative numbers of each type of wellhead are shown in the donut chart. In addition, a new shade (i.e., for section (706) of the cluster visualization (704)) indicates a fourth well state, such as “active”, but “declining” or “increasing” in production. In this example, the user instructed the interactive geographical map (700) to show clusters of wellheads having relatively stable production values as pie charts (e.g., cluster visualization (702)) but to show clusters of wellheads having at least some dynamic production values as a donut chart (e.g., cluster visualization (704)).

Attention is now turned to FIG. 3.7 and FIG. 3.8, which show widgets in association with cluster visualizations. FIG. 3.7 and FIG. 3.8 both show the cluster visualization (704) from FIG. 3.6. However, additional widgets are presented. For example, a zoom widget (800) is shown inside the inner circle of the cluster visualization (704), as presented in FIG. 3.7. A user, when using the interactive geographical map (700) shown in FIG. 3.6, may select the zoom widget (800) to increase the size of the cluster visualization (704), or possibly to increase the scale of the interactive geographical map (700), or both.

As shown in FIG. 3.8, a menu widget (802) may be selected by the user to generate a pop-up window (804). The user may select a property value within the pop-up window (804) to show or to hide. For example, for a particular cluster, the user may select to show all wells in the cluster, or only a portion of the wells (e.g., active wells, dry wells, disposal wells, or combinations thereof). Accordingly, in the example, the user may hide disposal wells and have the graph visualization show only active and dry wells (showing the pie chart or donut chart cluster visualizations in FIG. 3.5 as only being divided into two sections rather than three). By making a per cluster selection, the visualization is configurable on a per cluster basis. Thus, the user is able to adjust how the cluster visualization (704) in FIG. 3.7 and FIG. 3.8 is presented on the interactive geographical map (700) shown in FIG. 3.5. More or fewer properties could be shown in the pop-up window (804).

The one or more embodiments contemplate many different types of cluster visualizations. Thus, the pie charts and donut chart cluster visualizations shown in FIG. 3.2 through FIG. 3.8 may be varied. The cluster visualizations can take the form of bar graphs, multi-axial graphs, three-dimensional visualizations, animated objects, different forms of highlighting for different portions of a cluster visualization, and many other different representations. Thus, the one or more embodiments are not necessarily limited to the specific examples of cluster visualizations shown in FIG. 3.2 through FIG. 3.8.

FIG. 4.1 and FIG. 4.2 are examples of a computing system and a network, in accordance with one or more embodiments. The one or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 4.1, the computing system (400) may include one or more computer processor(s) (402), non-persistent storage device(s) (404) (e.g., volatile memory, such as random access memory (RAM), cache memory), persistent storage device(s) (406) (e.g., a hard disk, an optical drive such as a compact disk (CD) drive or digital versatile disk (DVD) drive, a flash memory, etc.), a communication interface (408) (e.g., Bluetooth interface, infrared interface, network interface, optical interface, etc.), and numerous other elements and functionalities that implement the features and elements of the disclosure.

The computer processor(s) (402) may be an integrated circuit for processing instructions. For example, the computer processor(s) (402) may be one or more cores or micro-cores of a processor. The computing system (400) may also include one or more input device(s) (410), such as a touchscreen, a keyboard, a mouse, a microphone, a touchpad, an electronic pen, or any other type of input device.

The communication interface (408) may include an integrated circuit for connecting the computing system (400) to a network (not shown) (e.g., a local area network (LAN), a wide area network (WAN) such as the Internet, a mobile network, or any other type of network) and/or to another device, such as another computing device.

Further, the computing system (400) may include one or more output device(s) (412), such as a screen (e.g., a liquid crystal display (LCD), a plasma display, a touchscreen, a cathode ray tube (CRT) monitor, a projector, or other display device), a printer, an external storage, or any other output device. One or more of the output device(s) (412) may be the same or different from the input device(s) (410). The input and output device(s) (410 and 412) may be locally or remotely connected to the computer processor(s) (402), the non-persistent storage device(s) (404), and the persistent storage device(s) (406). Many different types of computing systems exist, and the aforementioned input and output device(s) (410 and 412) may take other forms.

Software instructions in the form of computer readable program code to perform the one or more embodiments may be stored, in whole or in part, temporarily or permanently, on a non-transitory computer readable medium such as a CD, a DVD, a storage device, a diskette, a tape, flash memory, physical memory, or any other computer readable storage medium. Specifically, the software instructions may correspond to computer readable program code that, when executed by a processor(s), is configured to perform the one or more embodiments.

The computing system (400) in FIG. 4.1 may be connected to or be a part of a network. For example, as shown in FIG. 4.2, the network (420) may include multiple nodes (e.g., node X (422), node Y (424)). Each node may correspond to a computing system, such as the computing system (400) shown in FIG. 4.1, or a group of nodes combined may correspond to the computing system (400) shown in FIG. 4.1. By way of an example, the one or more embodiments may be implemented on a node of a distributed system that is connected to other nodes. By way of another example, the one or more embodiments may be implemented on a distributed computing system having multiple nodes, where each portion of the one or more embodiments may be located on a different node within the distributed computing system. Further, one or more elements of the aforementioned computing system (400) may be located at a remote location and connected to the other elements over a network.

Although not shown in FIG. 4.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system (400) shown in FIG. 4.1. Further, the client device (426) may include and/or perform all or a portion of the one or more embodiments.

The computing system (400) or group of computing systems described in FIGS. 4.1 and 4.2 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the one or more embodiments. The processes may be part of the same or different application and may execute on the same or different computing system.

Rather than or in addition to sharing data between processes, the computing system performing the one or more embodiments may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the one or more embodiments, may extract one or more data items from the obtained data. For example, the extraction may be performed as follows by the computing system (400) in FIG. 4.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as eXtensible Markup Language (XML)).

The extracted data may be used for further processing by the computing system. For example, the computing system (400) of FIG. 4.1, while performing the one or more embodiments, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system (400) in FIG. 4.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (a database, a table, a record, a column, a view, etc.), identifiers, conditions (comparison operators), functions (e.g. join, full join, count, average, etc.), sorts (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system (400) of FIG. 4.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system (400) of FIG. 4.1 and the nodes (e.g., node X (422), node Y (424)) and/or client device (426) in FIG. 4.2. Other functions may be performed using one or more embodiments.

While the one or more embodiments have been described with respect to a limited number of embodiments, those skilled in the art, having benefit of this disclosure, will appreciate that other embodiments can be devised which do not depart from the scope of the one or more embodiments as disclosed herein. Accordingly, the scope of the one or more embodiments should be limited only by the attached claims.

1. A method comprising:
receiving a command to cluster, on an interactive geographical map displayed in a graphical user interface (GUI), a plurality of objects, each object having a corresponding geographic location defined on the interactive geographical map and a plurality of property values of a plurality of properties;
generating a plurality of cluster visualizations, wherein generating the plurality of cluster visualizations comprises:
clustering, at least according to the corresponding geographic location, the plurality of objects into a plurality of clusters, and
creating a corresponding cluster visualization for each corresponding cluster of the plurality of clusters,
wherein, for at least one cluster visualization, the corresponding cluster visualization is created according to a property value of a property, of the plurality of properties, of at least some of the plurality of objects in the corresponding cluster; and
displaying the plurality of cluster visualizations on the interactive geographical map in the GUI.

2. The method of claim 1, wherein the plurality of cluster visualizations represent a plurality of well heads and wherein the plurality of property values comprises exploration and production (E&P) data for the plurality of well heads.

3. The method of claim 1, wherein clustering further comprises grouping the plurality of objects into different clusters according to one method selected from the group consisting of:
only the corresponding geographic location,
both the corresponding geographic location and the plurality of property values,
only the plurality of property values,
a weight of at least one of the corresponding geographic location and the plurality of property values.

4. The method of claim 1, further comprising:
altering, based on the plurality of property values, a shape of at least some of the plurality of cluster visualizations.

5. The method of claim 1, wherein displaying comprises:
displaying the plurality of cluster visualizations as a plurality of pie charts, the plurality of pie charts modified using the plurality of property values.

6. The method of claim 1, wherein displaying comprises:
displaying the plurality of cluster visualizations as a plurality of donut charts, the plurality of donut charts modified using the plurality of property values; and
displaying a corresponding widget within inner circles of the plurality of donut charts, wherein the corresponding widget is configured to further alter display of one or more of the plurality of donuts charts based on the plurality of property values.

7. The method of claim 1, wherein displaying comprises displaying the plurality of cluster visualizations as a plurality of graphs, the plurality of graphs modified using the plurality of property values.

8. The method of claim 1, wherein displaying further comprises highlighting different portions of each of the plurality of cluster visualizations based on at least some of the plurality of property values.

9. A system comprising:
a processor;
a data repository in communication with the processor and storing a plurality of objects having a corresponding geographic location and a plurality of property values of a plurality of properties;
a clustering process executable by the processor to:
cluster, at least according to the corresponding geographic location, the plurality of objects into a plurality of clusters, and
create a plurality of cluster visualizations for the plurality of clusters,
wherein at least one cluster visualization in the plurality of cluster visualizations is created according to a property value of a property, of the plurality of properties, of at least some of the plurality of objects in a corresponding cluster of the plurality of clusters; and
a map application executable by the processor and comprising:
a graphical user interface (GUI) comprising an interactive geographical map displaying the plurality of cluster visualizations, wherein the corresponding geographic location is defined on the interactive geographical map.

10. The system of claim 9, wherein the plurality of cluster visualizations represent a plurality of well heads and wherein the plurality of property values comprises exploration and production (E&P) data for the plurality of well heads.

11. The system of claim 9, wherein clustering process is further executable by the processor to cluster by one of:
grouping the plurality of objects into different clusters based on only the corresponding geographic location;
grouping the plurality of objects into different clusters based both the corresponding geographic location and the plurality of property values;
grouping the plurality of objects into different clusters based on only the plurality of property values; and
grouping the plurality of objects into different clusters based on a weight of at least one of the corresponding geographic location and the plurality of property values.

12. The system of claim 9, wherein the map application is further executable by the processor to modify the GUI by:
displaying the plurality of cluster visualizations as a plurality of donut charts, the plurality of donut charts modified using the plurality of property values; and
displaying a corresponding widget within inner circles of the plurality of donut charts, wherein the corresponding widget is configured to further alter display of one or more of the plurality of donuts charts based on the plurality of property values.

13. The system of claim 9, wherein the map application is further executable by the processor to modify the GUI by at least one of:
altering, using the plurality of property values, a shape of at least one of the plurality of cluster visualizations,
displaying the plurality of cluster visualizations as a plurality of pie charts, the plurality of pie charts modified using the plurality of property values,
displaying the plurality of cluster visualizations as a plurality of donut charts, the plurality of donut charts modified using the plurality of property values, and
displaying the plurality of cluster visualizations as a plurality of graphs, the plurality of graphs modified using the plurality of property values.

14. The system of claim 9, wherein the map application is further executable by the processor to further modify the GUI by highlighting different portions of each of the plurality of cluster visualizations based on at least some of the plurality of property values.

15. A graphical user interface (GUI) of a computing system, the graphical user interface comprising:
a display of a plurality of cluster visualizations on an interactive geographical map displayed on the GUI, wherein the plurality of cluster visualizations is formed by a processor executing a computer-implemented method comprising:
receiving a command to cluster, on the interactive geographical map displayed in the GUI, a plurality of objects, each object having a corresponding geographic location defined on the interactive geographical map and a plurality of property values of a plurality of properties;
generating a plurality of cluster visualizations, wherein generating the plurality of cluster visualizations comprises:
clustering, at least according to the corresponding geographic location, the plurality of objects into a plurality of clusters, and
creating a corresponding cluster visualization for each corresponding cluster of the plurality of clusters,
wherein, for at least one cluster visualization, the corresponding cluster visualization is created according to a property value of a property, of the plurality of properties, of at least some of the plurality of objects in the corresponding cluster; and
a widget displayed in association with at least one of the plurality of cluster visualizations, wherein the widget is operable by a user to alter, on the GUI, the at least one of the plurality of cluster visualizations.
